(19) United States
(12) Patent Application Publication
(10) Pub. No.: US 2011/0153841 A1
(43) Pub. Date: Jun. 23, 2011

(54) OPERATION SETTING METHOD OF RELAY APPARATUS, RELAY APPARATUS, AND STORAGE MEDIUM STORED WITH PROGRAM

(75) Inventor: Suguru Yoshida, Hamamatsu-shi (JP)

(73) Assignee: YAMAHA CORPORATION

(21) Appl. No.: 12/737,891

(22) PCT Filed: Aug. 28, 2009
(86) PCT No.: PCT/US2009/065102

§ 371 Date: Feb. 25, 2011

(30) Foreign Application Priority Data
Aug. 28, 2008 (JP) 2008-219122
Feb. 9, 2009 (US) 12322898

(51) Int. Cl. G06F 15/16

(52) U.S. Cl. 709/227

(57) ABSTRACT

A manipulation terminal is connected to a relay apparatus which is a target of operation setting, through a communication cable, and an address resolution request of which a target is an arbitrary IP address is broadcast-transmitted to the relay apparatus by the manipulation terminal. On the other hand, the relay apparatus performs a process of storing the target address of the address resolution request as a communication address and returning a MAC address of the relay apparatus to the manipulation terminal. A communication session is established between the manipulation terminal and the relay apparatus using the MAC address returned in this way, and the manipulation terminal performs the operation setting process through telnet.

### TECHNICAL FIELD

The present invention relates to a control technique which performs an operation setting of a relay apparatus such as a router.

### BACKGROUND ART

In a relay apparatus such as a router, in order to fulfill the original function thereof, it is necessary to perform a predetermined operation setting. Here, the operation setting is a process for setting and storing, in the relay apparatus, a communication address (for example, IP (Internet Protocol) address) or a subnet mask which identifies the relay apparatus through a network layer, or a communication address of a default gateway of a LAN (Local Area Network) to which the relay apparatus is connected. The default gateway is a relay apparatus disposed in a boundary between a LAN, for example, and an external communication network (for example, the Internet), and is a relay apparatus through which a packet transmitted or received between the communication apparatus in the LAN and the external communication apparatus necessarily passes.

However, the operation setting for an electronic device is generally realized by inputting a variety of commands for the operation setting, through user interface providing section such as a liquid crystal display or a keyboard. However, the relay apparatus such as a router does not require a command input during a normal operation, and thus, in many cases, is not provided with the above-described user interface providing section. Thus, when the operation setting of the relay apparatus is performed, a different computer apparatus (for example, notebook personal computer) which is provided with the user interface providing section is connected to the relay apparatus as a manipulation terminal, and various setting works are generally performed by manipulating the manipulation terminal.

There is a variety of specific methods for connecting the manipulation terminal to the relay apparatus. Firstly, the relay apparatus and the manipulation terminal are connected by a serial cable such as a USB (Universal Serial Bus) or a RS-232C. Secondly, the relay apparatus and the manipulation terminal are connected through a LAN. For example, in the case of the connection through a LAN, the relay apparatus and the manipulation terminal perform data communication (for example, telnet) using a communication address allocated to the relay apparatus or the manipulation terminal by a DHCP (Dynamic Host Configuration Protocol) server which is installed in a LAN, thereby making it possible to perform the operation setting of the relay apparatus. Further, a technique in which a communication address for an operation setting (hereinafter, operation setting address) is stored in the relay apparatus in advance, and the relay apparatus and the manipulation terminal perform data communication in which the operation setting address is used as a destination address, is disclosed in PTL 1.

### CITATION LIST

[PTL 1] JP-A-9-153902

### SUMMARY OF INVENTION

### Technical Problem

However, in a case where the manipulation terminal is connected by the serial cable, there is a problem that a device such as a serial cable, a USB cable, or a USB serial converter should be separately provided. On the other hand, in a case where the manipulation terminal is connected through a LAN, other devices are not required, but the following problem occurs. That is, in a case where the DHCP server is used, there occurs a problem in a case where a setting that the DHCP server is not used is performed in advance on the side of the relay apparatus or in a case where the DHCP server is not installed in the LAN. Further, in a case where the operation setting address is used, there is a problem that it is necessary to check the operation setting address in advance before the operation setting, or a problem that it is not possible to perform the operation setting in a case where the operation setting address cannot be used for some reason.

The invention is contrived to solve the above-described problems, and the object thereof is to provide a technique in which a device other than a computer apparatus which becomes a manipulation terminal and a LAN cable is not required even in a case where the DHCP server cannot be used, and an operation setting of the relay apparatus is performed without performing any preliminary checks.

### Solution to Problem

According to an embodiment of the invention, there is provided an operation setting method in a relay apparatus which relays data communication between a plurality of communication apparatuses through a LAN (Local Area Network) cable, wherein a manipulation terminal is connected to the relay apparatus, the method including: a first step of broadcast-transmitting an address resolution request whose target is an arbitrary communication address in a network layer to the relay apparatus by the manipulation terminal; a second step of controlling the relay apparatus to perform a process of storing the communication address which is the target of the address resolution request as an operation setting address and to perform a process of returning an address resolution response in which a communication address of the relay apparatus in a data link layer is written; and a third step of controlling the manipulation terminal to perform a process of establishing a communication session between the manipulation terminal and the relay apparatus according to the reception of the address resolution response and performing an operation setting for the relay apparatus through communication in the communication session.

According to such an operation setting method, the target address of the address resolution request broadcast-transmitted from the manipulation terminal connected to the relay apparatus which is the target of the operation setting through the LAN cable is set in the relay apparatus as the operation setting address. Thus, the manipulation terminal can perform data communication with the relay apparatus using the operation setting address as a destination address, and thus, the operation setting of the relay apparatus is performed by the data communication. Accordingly, it is not necessary to check whether the operation setting address is set in the relay apparatus, and any problem does not occur even though the DHCP cannot be used. Further, since the manipulation terminal is connected to the relay apparatus through the LAN cable, other devices such as a USB serial converter other than the LAN cable are not necessary.

Further, according to an embodiment of the invention, there is provided a relay apparatus including: a communication section configured to connect to a plurality of communication apparatuses; a storage section configured to store setting information which is referenced when data communication is relayed between the communication apparatuses connected to the communication section; and a control section that performs a first process of storing, in a case where an address resolution request whose target is an arbitrary communication address in a network layer is received through the communication section, the communication address which is the target of the address resolution request in the storage section as an operation setting address and returning an address resolution response in which a communication address of the relay apparatus in a data link layer is written, and a second process of establishing a communication session between the relay apparatus and a transmission source of the address resolution request according to the request from the transmission source and storing setting information which is received in the communication session in the storage section. Further, there is provided a recording medium which stores therein a program for causing a computer to execute the first and second processes performed by the control section.

Preferably, the communication address of the network layer allocated to the relay apparatus is included in the setting information which is stored in the storage medium of the relay apparatus, and the communication section includes a plurality of ports to which the communication apparatuses are respectively connected through LAN cables, and the control section classifies the plurality of ports into a port to which the manipulation terminal is connected and the other ports by a port VLAN (Virtual Local Area Network) function, allocates the communication address which is the target of the address resolution request to the port to which the manipulation terminal is connected, and allocates the communication address included in the setting information stored in the storage section to the other ports. According to such an embodiment, the communication address of the port to which the manipulation terminal is connected is reset as a communication address included in the setting information, to thereby prevent cutoff of the communication session between the manipulation terminal and the relay apparatus.

Preferably, the control section performs the first and second processes when the address resolution request is received through a port preset for an operation setting among the plurality of ports, when an operation in an operation setting mode is instructed, or when the address resolution request is received in a state where the setting information is not stored in the storage section. According to such an embodiment, it is possible to reliably distinguish the address resolution request transmitted for operation setting from the address resolution request transmitted in a general data communication process.

### BRIEF DESCRIPTION OF DRAWINGS

FIG. 1 is a diagram illustrating a configuration example of a relay apparatus 10 according to an embodiment of the invention.

FIG. 2 is a diagram illustrating functions of a communication I/F section 120 in the relay apparatus 10.

FIG. 3 is a flowchart illustrating a flow of an operation setting method according to an embodiment of the invention.

FIG. 4 is a diagram illustrating an outline of an operation performed by the relay apparatus 10.

### DESCRIPTION OF EMBODIMENTS

Hereinafter, preferred embodiments according to the invention will be described.

(A: Configuration)

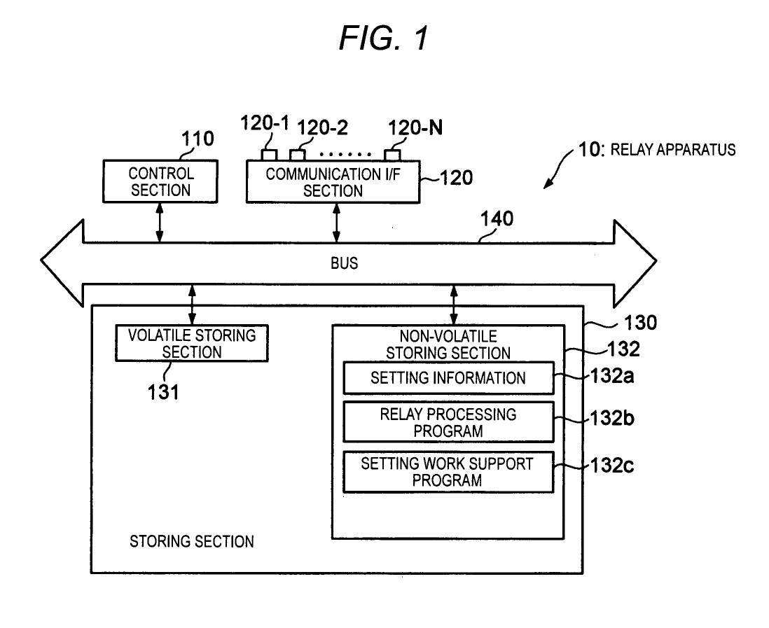

FIG. 1 is a diagram illustrating a configuration example of a relay apparatus 10 according to an embodiment of the invention. The relay apparatus 10 is a router which relays data communication between a plurality of communication apparatuses (for example, personal computers (hereinafter, “PC”) which function as communication terminals) or other relay apparatuses, and includes a control section 110, a communication interface (hereinafter, “I/F”) section 120, a storing section 130 and a bus 140 which mediates data communication between these components, as shown in FIG. 1.

The control section 110 is a CPU (Central Processing Unit), for example. The control section 110 performs a variety of processes according to a variety of programs stored in the storing section 130, and functions as a control center (control section) which performs an operation control of each section of the relay apparatus 10. Details of the operation performed by the control section 110 according to the various programs will be specifically described later.

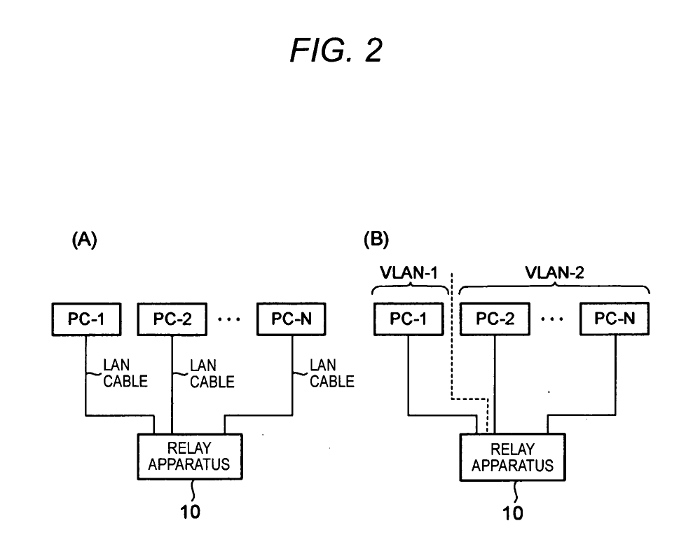

The communication I/F section 120 is an NIC (Network Interface Card), for example, which functions as a communication section to which other communication apparatuses are connected and which performs data communication with the connection destinations. The communication I/F section 120 includes a plurality of ports (ports indicated by a reference numeral 120-k (k is 1 to N, where N is a natural number of 2 or more) in FIG. 1)) to which LAN cables such as a 10BASE-T, 100BASE-T, or the like are respectively connected. Other communication apparatuses are connected to these LAN cables. For example, FIG. 2(A) illustrates a case where personal computers PC-k (k is 1 to N) are connected to the respective ports 120-k (k is 1 to N) of the relay apparatus 10. The communication I/F section 120 performs a process of delivering data received from a communication apparatus which is the connection destination thereof through each port 120-k to the control section 110, and transmitting data delivered from the control section 110 to the destination through the port 120-k according to the destination. Further, a MAC (Media Control Address) address which is a communication address which identifies the relay apparatus 10 through a data link layer thereof is allocated in advance to the communication I/F section 120.

The storing section 130 functions as a storage section which stores various data and various programs. As shown in FIG. 1, the storing section 130 includes a volatile storing section 131 and a non-volatile storing section 132. The volatile storing section 131 is a volatile memory such as a RAM (Random Access Memory) or the like, for example, which is used as a work area when various programs are executed, by the control section 110. On the other hand, the non-volatile storing section 132 is a non-volatile memory such as a Flash ROM (Read Only Memory), a hard disk or the like. In the non-volatile storing section 132, a program which allows the control section 110 to execute a process of noticeably indicating characteristics of the relay apparatus 10 according to this embodiment is stored, and data referenced in the execution process is also stored.

As an example of the data stored in the non-volatile storing section 132, setting information 132a is exemplified. The setting information 132a is data for regulating an operation of the control section 110 when data communication between the plurality of communication apparatuses which is connected to the communication I/F section 120 is relayed, and is referenced in the execution process of the data relay process. As an example of the data included in the setting information 132a, data indicating a communication address (IP address) in a network layer, allocated to the relay apparatus 10, a subnet mask or the like, are exemplified.

On the other hand, as an example of the program stored in the non-volatile storing section 132, a relay processing program 132b or a setting work support program 132c are exemplified. The relay processing program 132b is a program which allows the control section 110 to execute the above-described data relay process. On the other hand, the setting work support program 132c is a program which supports the operation setting of the relay apparatus 10 by allowing the relay apparatus 10 to execute a process of performing communication with other communication apparatuses through a LAN in such a manner that the characteristics of this embodiment are noticeably shown, and of writing the setting information 132a in the non-volatile storing section 132. In this embodiment, the relay apparatus 10 includes two operation modes of a data relay mode and an operation setting mode. In the relay apparatus 10 is installed a mode switch for instructing the relay apparatus 10 to operate in any one of two operation modes (not shown in FIG. 1). In a case where the relay apparatus 10 is instructed to operate in the data relay mode through manipulation for the mode switch, the control section 110 reads out the relay processing program 132b from the non-volatile storing section 132 to the volatile storing section 131 for execution, and in a case where the relay apparatus 10 is instructed to operate in the operation setting mode, the control section 110 reads out the setting work support program 132c from the non-volatile storing section 132 to the volatile storing section 131 for execution. In this embodiment, the mode switch for performing switching of two operation modes is installed in the relay apparatus 10, but the relay apparatus 10 may be configured so that the relay apparatus 10 operates in the operation setting mode without any condition at the time of factory shipment, and does not operate in the data relay mode unless any other operation setting is performed. If the initial setting is performed at the time of the factory shipment in this way, the mode switch is not necessarily installed.

The relay apparatus 10 has the above described configuration.

(B: Operation)

Hereinafter, an operation setting method of the relay apparatus 10 according to this embodiment will be described, in which a process performed by the control section 110 according to the setting work support program 132c will mainly be described.

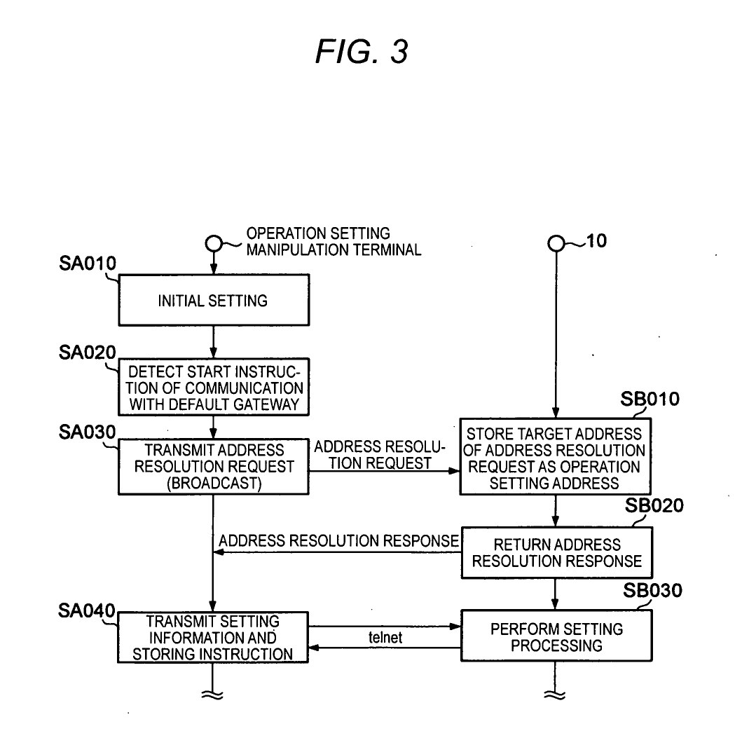

As shown in FIG. 1, the relay apparatus 10 does not include a user interface providing section (output device such as a liquid crystal display or the like or input device such as a keyboard or the like) for inputting data forming the setting information 132a such as a subnet mask or the like. Thus, a person who desires to perform the operation setting of the relay apparatus 10 (for example, a manager of the relay apparatus 10, hereinafter, referred to as a setting operator) connects a computer apparatus (for example, a notebook PC or the like) which functions as a manipulation terminal during the setting operation to any of ports 120-k (k is 1 to N) through a LAN cable, and manipulates the mode switch to give an operation instruction in the operation setting mode to the relay apparatus 10. Thus, execution of the setting work support program 132c is started in the relay apparatus 10. Subsequently, the setting operator performs an initial setting of the manipulation terminal in order to enable data communication with the relay apparatus 10 (step SA010 in FIG. 3). Specifically, the setting operator manipulates a manipulation section (not shown) of the manipulation terminal, and sets a communication address or a subnet mask (for example, 192.168.100.10/24) in the network layer allocated to the manipulation terminal, a communication address (for example, 192.168.100.1, hereinafter, referred to as a default gateway address) of a default gateway for the LAN to which the relay apparatus 10 is connected, or the like. The default gateway address in this embodiment is provisionally set in the manipulation terminal, and is used only during the operation setting mode. Further, the default gateway address may be an address which is preset in the manipulation terminal or an address which is arbitrarily set. Further, in a case where the relay apparatus is operated as the default gateway after the operation setting mode is completed, the default gateway address used in the operation setting mode may be used as it is.

If the initial setting with respect to the manipulation terminal is completed as described above, the setting operator gives the manipulation terminal an instruction of the start of telnet communication with the default gateway. Then, the control section of the manipulation terminal detects the instruction (step SA020), and broadcast-transmits an address resolution request (for example, “ARP request”) in which the default gateway address is written in order to obtain the MAC address of the default gateway (step SA030). The address resolution request transmitted in this way reaches the relay apparatus 10 through the LAN cable.

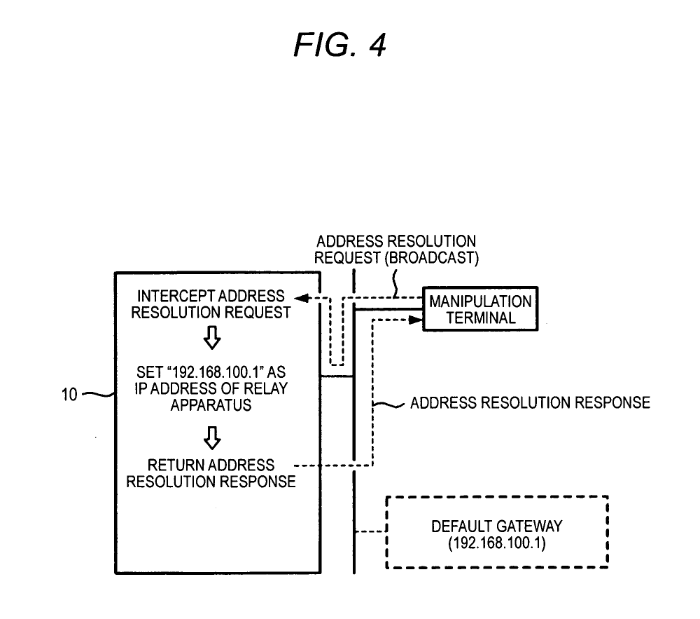

If the address resolution request transmitted from the manipulation terminal is received through the communication I/F section 120, the control section 110 of the relay apparatus 10 which operates in the operation setting mode appropriately sets the subnet mask, allocates an IP address of a resolution target of the address resolution request to the communication I/F section 120 as a communication address of the relay apparatus 10 (step SB010), and returns an address resolution response (for example, “ARP response”) in which the MAC address of the communication I/F section 120 is written (step SB020). Thus, a communication address “192.168.100.1” is allocated to the communication I/F section 120 of the relay apparatus 10, and the MAC address of the relay apparatus 10 is returned to the manipulation terminal as the MAC address of the communication apparatus having the corresponding IP address. That is, in this embodiment, as shown in FIG. 4, the relay apparatus 10 intercepts the address resolution request of the default gateway destination to temporarily pretend to be the default gateway. In this way, the address resolution response returned from the relay apparatus 10 reaches the manipulation terminal through the communication cable. A value of the subnet mask set in step SB010 may be determined in advance through experiments.

The manipulation terminal which receives the address resolution response returned as described above establishes a communication session between the transmission source (that is, the relay apparatus 10) and the manipulation terminal, using the MAC address notified through the address resolution response. Thus, the manipulation terminal and the relay apparatus 10 can perform data communication based on the telnet. In this embodiment, if the communication based on the telnet can be performed as described above, the setting operator inputs various setting information to be stored in the relay apparatus 10, a command indicating the storing, and the like to the manipulation terminal, and then allows the manipulation terminal to transmit the setting information and the command (step SA040). On the other hand, the control section 110 of the relay apparatus 10 performs a process of receiving the setting information and the command indicating the storing transmitted based on the telnet, storing the setting information according to the command, and setting the communication address included in the setting information in the communication I/F section 120 (step SB030). Thus, the operation setting of the relay apparatus 10 is performed. If the communication address included in the setting information transmitted from the manipulation terminal is set in the communication I/F section 120 in this way, the communication session between the manipulation terminal and the relay apparatus 10 is cut off. However, since the operation setting for the relay apparatus 10 is completed, a significant problem does not occur even though the communication session is cut off.

If an operation in a data relay mode is instructed by manipulating the mode switch after the operation setting is completed in this way, the control section 110 starts execution of the relay processing program 132b, and performs the data relay process based on the setting information 132a which is stored in the non-volatile storing section 132. In this embodiment, the switching to the data relay mode from the operation setting mode is performed by switching of the mode switch, but a command instructing such switching of the operation mode may be given to the relay apparatus 10 from the manipulation terminal through telnet communication, or the control section 110 may perform a process of automatically switching the relay apparatus 10 to the data relay mode when the writing of the setting information in the non-volatile storing section 132 is completed.

As described above, in this embodiment, since the target address of the address resolution request transmitted from the manipulation terminal is used as the operation setting address of the relay apparatus 10, it is not necessary to store in advance the operation setting address in the relay apparatus 10, nor to perform a preliminary check with respect to whether the operation setting address is set in the relay apparatus 10. Further, it is not necessary to use a DHCP server, and not necessary to require a device other than a PC which functions as the manipulation terminal during the operation setting work and a LAN cable. That is, according to this embodiment, even when the DHCP server cannot be used, no tools other than the computer apparatus which is the manipulation terminal and the LAN cable is necessary, and it is possible to perform the operation setting of the relay apparatus without any preliminary checks.

(C: Modifications)

Hereinbefore, the exemplary embodiment of the invention has been described, but modifications which will be described hereinafter may be applied to this embodiment. (1) In the above-described embodiment, as the communication address which is temporarily allocated to the relay apparatus 10 for operation setting, the IP address of the default gateway for the LAN to which the relay apparatus 10 is connected is used, but an IP address of any other communication apparatus may be used, or any one which does not coincide with any IP address of the communication apparatus connected to the LAN may be used. That is, it is possible to use an arbitrary IP address (here, it should be different from the communication address allocated to the manipulation terminal) as the communication address which is temporarily allocated to the relay apparatus 10 for operation setting. Further, in the above-described embodiment, when the start of the telnet communication with the default gateway is instructed, the address resolution request of which the resolution target is the IP address of the default gateway is transmitted to the manipulation terminal, but when the start of communication based on other communication protocols such as an FTP (File Transfer Protocol) or an HTTP (Hypertext Transfer Protocol) is instructed, the address resolution request may be transmitted, or a user may directly instruct the transmission of the address resolution request.

(2) In the above-described embodiment, in a case where the operation in the operation setting mode is instructed, the control section 110 starts execution of the setting work support program 132c, and performs a setting support process (that is, a process of intercepting the address resolution request and performing the data communication for the operation setting by pretending to be the destination) according to the setting work support program 132c. However, in a case where the address resolution request is received through a specific port among the plurality of ports included in the communication I/F section 120, the performance of the setting support process may be started. Specifically, in a case where any of the plurality of ports included in the communication I/F section 120 is determined in advance as an operation setting port and the address resolution request is received through the operation setting port, the performance of the setting support process is started. Further, in a case where the address resolution request is received in a state where the operation setting is not performed (that is, in a state where the setting information 132a is not stored in the non-volatile storing section 132), or in a case where the DHCP cannot be used (in a case where the DHCP server is not installed in the LAN to which the relay apparatus 10 is connected, or in a case where the setting for use of the DHCP is not performed), the performance of the setting support process may be started. That is to say, as long as the address resolution request transmitted or received in the execution process of a general data communication and the address resolution request transmitted for the operation setting can be distinguished from each other, any modification may be applied.

(3) In a case where the relay apparatus 10 includes the port VLAN function, the plurality of ports installed in the communication I/F section 120 may be classified into a port to which the manipulation terminal is connected and the others ports, using the port VLAN function. Then, the target address of the address resolution request may be allocated to the port to which the manipulation terminal is connected, and the communication address included in the setting information transmitted from the manipulation terminal may be allocated to the other ports. According to such a modification, after the operation setting based on the setting information transmitted from the manipulation terminal is performed, it is possible to maintain the communication session between the manipulation terminal and the relay apparatus 10. The port VLAN function is a function of grouping the other communication apparatuses connected to the respective ports 120-k (k is 1 to N) into a single VLAN or a plurality of VLANs in the unit of ports, and of controlling data communication for every VLAN. For example, in FIG. 2(B), the personal computers PC-k (k is 1 to N) which are connected one by one to the respective ports 120-k (k is 1 to N) may be grouped into two sets of VLAN-1 and VLAN-2. In an example shown in FIG. 2(B), the VLAN-1 is formed by the PC-1 and the relay apparatus 10, and the VLAN-2 is formed by the PC-2 to PC-N and the relay apparatus 10. In the example as shown in FIG. 2(B), if any communication message from the PC-2 is broadcast-transmitted, a communication control is performed so that the communication message is transferred to the other communication apparatuses in the VLAN-2 except the PC-2, but is not transferred to the PC-1. Similarly, in the example shown in FIG. 2(B), even though any communication message from the PC-1 is broadcast-transmitted, the communication message is not transferred to the side of the VLAN-2.

(4) In the above-described embodiment, the setting work support program 132c for allowing the control section 110 of the relay apparatus 10 to realize the operation setting method according to the invention is stored in advance in the non-volatile storing section 132. However, the program may be written in a computer readable recording medium such as a CD-ROM (Compact Disk-Read Only Memory) for distribution, or the program may be downloaded through an electronic communication line such as the Internet for distribution. As the setting work support program distributed in this way is stored in a general relay apparatus and the control section is operated according to the setting work support program, it is possible to give the same function as the relay apparatus according to the invention to the general relay apparatus.

### REFERENCE SIGNS LIST

10: RELAY APPARATUS
110: CONTROL SECTION
120: COMMUNICATION I/F SECTION
120-k (k IS 1 TO N, N IS A NATURAL NUMBER OF 2 OR MORE): PORT
130: STORING SECTION
131: VOLATILE STORING SECTION
132: NON-VOLATILE STORING SECTION
132a: SETTING INFORMATION
132b: RELAY PROCESSING PROGRAM
132c: SETTING WORK SUPPORT PROGRAM
140: BUS

1. An operation setting method in a relay apparatus which relays data communication between a plurality of communication apparatuses through a LAN (Local Area Network) cable, wherein a manipulation terminal is connected to the relay apparatus, the method comprising:
a first step of broadcast-transmitting an address resolution request whose target is an arbitrary communication address in a network layer to the relay apparatus by the manipulation terminal;
a second step of controlling the relay apparatus to perform a process of storing the communication address which is the target of the address resolution request as an operation setting address and to perform a process of returning an address resolution response in which a communication address of the relay apparatus in a data link layer is written; and
a third step of controlling the manipulation terminal to perform a process of establishing a communication session between the manipulation terminal and the relay apparatus according to a reception of the address resolution response and performing an operation setting for the relay apparatus through communication in the communication session.

2. A relay apparatus comprising:
a communication section configured to connect to a plurality of communication apparatuses;
a storage section configured to store setting information which is referenced when data communication is relayed between the communication apparatuses connected to the communication section; and
a control section that performs a first process of storing, in a case where an address resolution request whose target is an arbitrary communication address in a network layer is received through the communication section, the communication address which is the target of the address resolution request in the storage section as an operation setting address and returning an address resolution response in which a communication address of the relay apparatus in a data link layer is written, and a second process of establishing a communication session between the relay apparatus and a transmission source of the address resolution request according to the request from the transmission source and storing setting information which is received in the communication session in the storage section.

3. The relay apparatus according to claim 2, wherein the communication address of the network layer allocated to the relay apparatus is included in the setting information, and the communication section includes a plurality of ports to which the communication apparatuses are respectively connected through LAN cables; and
wherein the control section classifies the plurality of ports into a port to which the manipulation terminal is connected and the other ports by a port VLAN (Virtual Local Area Network) function, allocates the communication address which is the target of the address resolution request to the port to which the manipulation terminal is connected, and allocates the communication address included in the setting information stored in the storage section to the other ports.

4. The relay apparatus according to claim 3, wherein the control section performs the first and second processes when the address resolution request is received through a port preset for an operation setting among the plurality of ports.

5. The relay apparatus according to claim 2, wherein the control section performs the first and second processes when an operation in an operation setting mode is instructed, or when the address resolution request is received in a state where the setting information is not stored in the storage section.

6. A recording medium which stores therein a program for causing a computer to execute the processes comprising:
a first process of receiving an address resolution request whose target is an arbitrary communication address in a network layer from a manipulation terminal connected to the computer apparatus, storing the communication address which is the target of the address resolution request as an operation setting address, and returning an address resolution response in which a communication address in a data link layer allocated to the subject apparatus is written; and
a second process of establishing a communication session between the computer apparatus and the manipulation terminal according to the request from the manipulation terminal and receiving, from the manipulation terminal, setting information referenced when data communication is relayed between communication apparatuses connected to the computer apparatus, for storage.
